(19) United States
(12) Patent Application Publication
(10) Pub. No.: US 2018/0194194 A1
(43) Pub. Date: Jul. 12, 2018

(54) AIR CONTROL METHOD AND SYSTEM BASED ON VEHICLE SEAT STATUS

(71) Applicant: Faraday&Future Inc., Gardena, CA (US)

(72) Inventors: Anna Angelica Lyubich, Sunnyvale, CA (US); Carlos John Rosario, San Jose, CA (US)

(21) Appl. No.: 15/662,220

(22) Filed: Jul. 27, 2017

Related U.S. Application Data
(60) Provisional application No. 62/368,021, filed on Jul. 28, 2016.

(51) Int. Cl. B60H 1/00; B60N 2/56; B60N 2/00

(52) U.S. Cl. CPC B60H 1/00742; B60H 1/00285; B60H 1/0075; B60N 2/002; B60N 2/5628

(57) ABSTRACT

An air control system is disclosed. The system may comprise a processing unit. The processing unit may be configured to receive a seat status, and adjust an air control device based on the received seat status.

### CROSS-REFERENCE TO RELATED APPLICATIONS

This application claims the benefit of U.S. Provisional Application No. 62/368,021, filed Jul. 28, 2016, the entirety of which is hereby incorporated by reference.

### TECHNICAL FIELD

The present disclosure relates generally to methods and systems for air control, and more particularly, to air control methods and systems based on vehicle seat status.

### BACKGROUND

Modern vehicle seats can have many configurations. For example, a passenger seat can be turned in 360 degrees with respect to the vertical direction. The same function can be applied to a driver's seat for an autonomous vehicle. Such design can facilitate communication and interaction among passengers, since talking between front row and back row passengers is commonly found difficult in traditional vehicles with forward facing seats.

Current vehicle air control technologies, however, have not been adequately improved for such seat configurations. For example, air flow in current vehicles does not sufficiently reach occupants on reversed seats (that is, when the seats are facing the rear of the vehicle), causing uncomfortable sensations such as too hot or too cold.

### SUMMARY

One aspect of the present disclosure is directed to an air control system. The system may comprise a processing unit. The processing unit may be configured to receive a seat status and adjust an air control device based on the received seat status.

Another aspect of the present disclosure is directed to a vehicle. The vehicle may comprise an air control system. The system may comprise a processing unit configured to receive a seat status and adjust an air control device based on the received seat status.

Another aspect of the present disclosure is directed to a method for air control. The method may comprise receiving a seat status and adjusting an air control device based on the received seat status.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this disclosure, illustrate several embodiments and, together with the description, serve to explain the disclosed principles.

FIG. 1 is a graphical representation illustrating a vehicle for air control based on a vehicle seat status from a top view, consistent with exemplary embodiments of the present disclosure.

FIG. 2 is a graphical representation illustrating a vehicle for air control based on a vehicle seat status from a perspective view, consistent with exemplary embodiments of the present disclosure.

FIG. 3 is a graphical representation illustrating another vehicle for air control based on a vehicle seat status from a side view, consistent with exemplary embodiments of the present disclosure.

FIG. 4 is a block diagram illustrating an air control system, consistent with exemplary embodiments of the present disclosure.

FIG. 5 is a flowchart illustrating an air control method, consistent with exemplary embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention.

Current technologies are not adequate to control air flow for various seat configurations in a vehicle. For example, people sitting on reversed seats may experience poor air control during a vehicle ride. The disclosed systems and methods may mitigate or overcome one or more of the problems set forth above and/or other problems in the prior art.

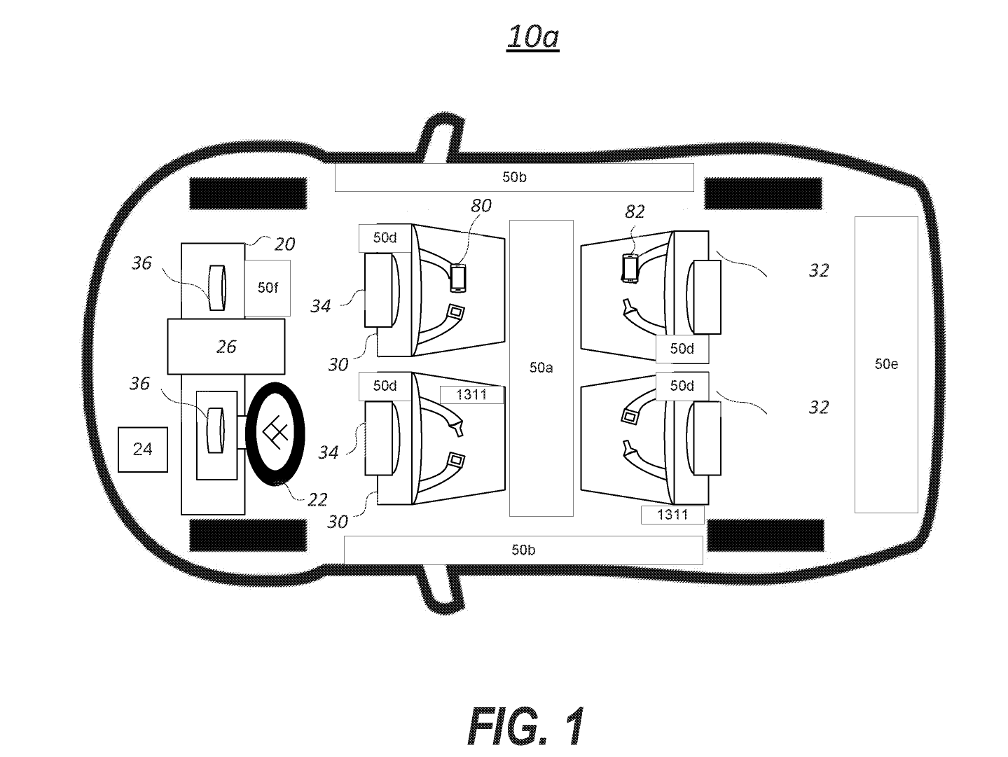

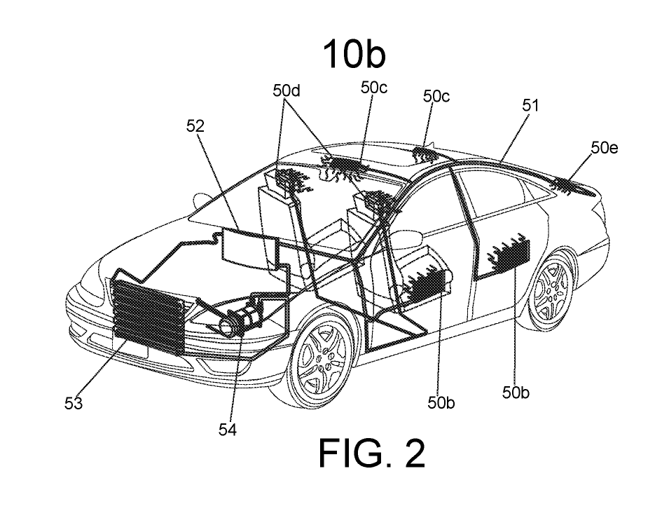

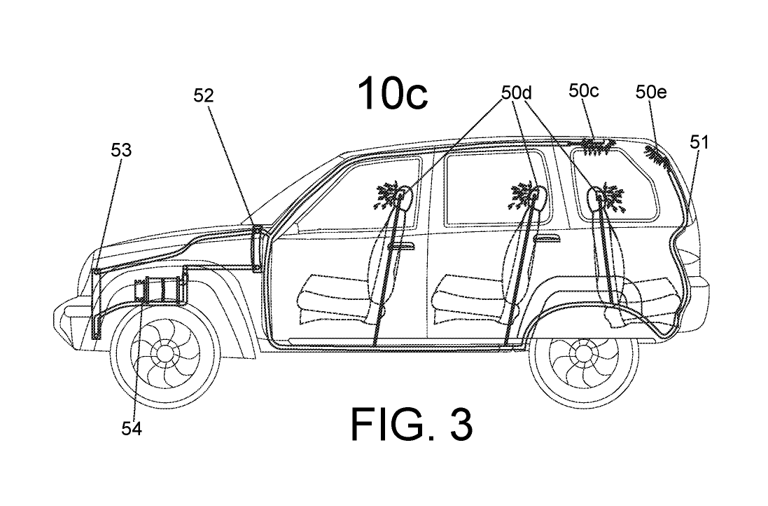

FIG. 1 is a graphical representation illustrating a vehicle 10a for air control based on a vehicle seat status from a top view, consistent with exemplary embodiments of the present disclosure. FIG. 2 is a graphical representation illustrating a vehicle 10b for air control based on a vehicle seat status from a perspective view, consistent with exemplary embodiments of the present disclosure. FIG. 3 is a graphical representation illustrating a vehicle 10c for air control based on a vehicle seat status from a side view, consistent with exemplary embodiments of the present disclosure. Vehicle 10a, vehicle 10b, and vehicle 10c are exemplary embodiments of vehicle 10. Vehicle 10 may have any body style of an automobile, such as a sports car, a coupe, a sedan (e.g., vehicle 10b), a pick-up truck, a station wagon, a sports utility vehicle (e.g., SUV 10c), a minivan, or a conversion van. Vehicle 10 may also embody other types of transportation, such as motorcycles, boats, buses, trains, and planes. Vehicle 10 may be an electric vehicle, a fuel cell vehicle, a hybrid vehicle, or a conventional internal combustion engine vehicle. Vehicle 10 may be configured to be operated by a driver occupying vehicle 10, remotely controlled, and/or autonomous. That is, the methods described herein can be performed by vehicle 10 with or without a driver.

As illustrated in FIG. 1, vehicle 10 may include a number of components, some of which may be optional. Vehicle 10 may have a dashboard 20 through which a steering wheel 22 and a user interface 26 may project. In one example of an autonomous vehicle, vehicle 10 may not include steering wheel 22. Vehicle 10 may also have one or more front seats 30 and one or more back seats 32 configured to accommodate occupants. Front seats 30 and back seats 32 may be rotatable. For example, front seats 30 and back seats 32 may be rotated to face forward, left, right, or backward. Front seats 30 and back seats 32 may include one or more seat sensors 1311 configured to detect a seat status, such as a seat direction (e.g., facing front, side, or back of the vehicle, the direction that the seat faces with respect to the vertical direction, and/or its yaw, pitch, or roll angle of the seat in the 3D space). For example, seat sensors 1311 may comprise one or more gimbals. Seat sensors 1311 may be embedded in or attached to the seats. Vehicle 10 may further include one or more sensors 36 disposed at various locations of the vehicle and configured to detect and recognize occupants and/or perform other functions as described below. Vehicle 10 may also include a detector and GPS unit 24 disposed in front of steering wheel 22, on the top of the vehicle, or at other locations to detect objects, receive signals (e.g., GPS signal), and/or transmit data. Detector and GPS unit 24 may determine in real time the location of vehicle 10 and/or information of the surrounding environment, such as street signs, lane patterns, road marks, road conditions, environment conditions, weather conditions, and traffic conditions. The detector may include an onboard camera. Vehicle 10 may also include one or more air control devices 50 (e.g., air control devices 50a-50f) disposed at various positions.

The positions of the various components of vehicle 10 in FIG. 1, FIG. 2, and FIG. 3 are merely illustrative and are not limited as shown in the figures. For example, sensor 36 may include an infrared sensor disposed on a door next to an occupant, or a weight sensor embedded in a seat; detector and GPS unit 24 may be disposed at another position in the vehicle; user interface 26 may be installed in front of each vehicle occupant; and additional air control devices 50 can be disposed at other positions of the vehicle.

In some embodiments, air control devices 50a-50f may include air outlets configured to deliver a controlled air to a configurable position in a configurable direction. Air control devices 50 may be configured to control at least one of a temperature, a wind speed, a humidity, a vapor content, a scent, or a diffusion content of the controlled air. Air control devices 50 may also comprise one or more ducts, fans, vents, and/or blowers configured to facilitate controlled air flowing in a configurable direction and location.

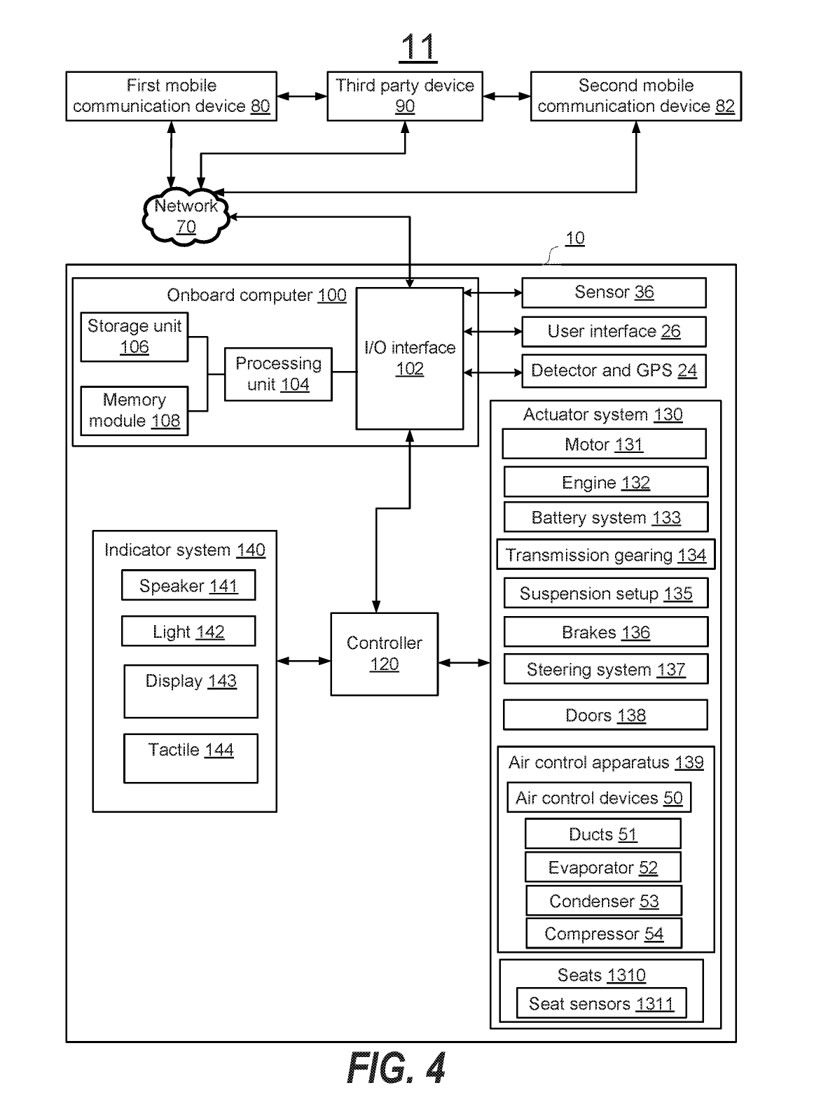

In some embodiments, air control devices 50 may be a part of an air control apparatus 139 described below with reference to FIG. 4. As shown in FIGS. 2 and 3, in addition to air control devices 50, air control apparatus 139 may comprise one or more ducts 51, an evaporator 52, a condenser 53, and a compressor 54, all of which may be inter-connected. Exemplary connections are illustrated in FIGS. 1-3. Air control apparatus 139 may produce the controlled air and deliver the controlled air to various positions of the vehicle. Air control apparatus 139 may also control at least one of a temperature, a wind speed, a humidity, a vapor content, a scent, or a diffusion content of the controlled air. In one example, a duct 51 may connect an air control devices 50 to evaporator 52 or condenser 53. Air control devices 50 may also include an optional blower. The ducts 51 may or may not be a part of the air control devices 50. The ducts 51 may form a duct network to transport the controlled air from evaporator 52, condenser 53, and/or compressor 54 to air control devices 50. Thus, generated controlled air can be delivered to various positions of the vehicle by air control devices 50.

In some embodiments, air control devices 50a-50f may be disposed at various positions of vehicle 10. FIG. 1, FIG. 2, and FIG. 3 illustrate various embodiments of air control devices 50. In FIG. 2, front row seats are shown in a reversed status. In FIG. 3, a first row seat and a second row seat of a SUV are shown facing the front of the vehicle, and a third row seat of the SUV is shown in a reversed status. Dash lines of the seats represent parts where the view is blocked. With respect to air control devices 50, for example, air control device 50a (shown in FIG. 1) may be disposed at a floor of vehicle 10, the floor including areas under seats 30 and 32; air control device 50b (shown in FIGS. 1 and 2) may be disposed at one or more doors of vehicle 10; air control device 50c (shown in FIGS. 2 and 3) may be disposed at a ceiling of vehicle 10; air control device 50d (shown in FIGS. 1, 2, and 3) may be disposed at head rests of seats 30 and 32; air control device 50e (shown in FIGS. 2 and 3) may be disposed at a rear of vehicle 10, e.g., at the back of seats 32, or at a lift gate; and air control device 50f (shown in FIG. 1) may be disposed below dashboard 20. By being described as “disposed at or on an object,” the air control devices 50a-50f may be integrated with or attached to a body or various components of vehicle 10. For example, air control device 50d may be disposed at one side or both sides of one or more head rests or be integrated with one or more head rests.

Referring to FIG. 3, air control device 50e may be disposed at various positions at the rear of the vehicle. For example, air control device 50e can be disposed to face a reversed third row seat, and/or can be disposed at an upper positon of the SUV's lift gate to facilitate circulation of cool air since cool air is heavier than warm air. As shown in FIGS. 2 and 3, ducts 51 may connect to various components of air control apparatus 139 to transport the controlled air.

In some embodiments, each of air control devices 50 may be associated with one or more seats and/or one or more statuses of a seat. For example, the front passenger seat may be associated with a first number of air control devices (e.g., air control device 50f) when facing the front of the vehicle, and may be associated with a second number of air control devices (e.g., air control devices 50a and 50b) when facing the back of the vehicle.

In some embodiments, air control devices 50 can be individually or collectively controlled by a processing unit described below with reference to FIG. 4 via various interfaces and devices. For example, the direction of air flow from the outlet of an air control device can be controlled. The air outlets of air control devices may be disposed on a movable track, so the position of the air outlets can also be controlled.

In some embodiments, air control devices 50 may include one or more speakers, humidifier, vaporizer, or air diffuser. For example, removable speakers can be integrated with outlets of air control devices 50 to achieve cooling and sound effect in one device. For another example, the humidifier, vaporizer, or air diffuser may be integrated with outlets of air control devices 50 or may be integrated into air control apparatus 139, so that the controlled air is humidified, vaporized, scented, or contains predetermined diffusion contents such as water vapor, steam, or mist. The humidifier, vaporizer, or air diffuser may have automatic cleaning systems, and may be individually controlled. For example, a user can configure the type of scent or the level of humidity through mobile communication devices 80, 82, or user interface 26.

In some embodiments, seats 30, 32 may comprise coolers disposed at various positons, e.g., on the seat, or at a back, neck, or head rest. The coolers can be individually activated and can be controlled manually or automatically. The coolers may be liquid-cooled. For example, the coolers can turn on or off based on user profiles and associated preferences. Vehicle occupant identification and profile establishment are described in more details below with reference to method 500.

In some embodiments, user interface 26 may be configured to receive inputs from users or devices and transmit data. For example, user interface 26 may have a display including an LCD, an LED, a plasma display, or any other type of display, and provide a graphical user interface (GUI) presented on the display for user input and data display. User interface 26 may further include speakers or other voice playing devices. User interface 26 may further include input devices, such as a touchscreen, a keyboard, a mouse, a microphone, and/or a tracker ball, to receive a user input. User interface 26 may also connect to a network to remotely receive instructions or user inputs. Thus, the input may be directly entered by a current occupant, captured by interface 26, or received by interface 26 over the network. User interface 26 may further include a housing having grooves containing the input devices. User interface 26 may be configured to provide internet access, cell phone access, and/or in-vehicle network access, such as Bluetooth™, CAN bus, or any other vehicle bus architecture protocol that may be used to access features or settings within vehicle 10. User interface 26 may be further configured to display or broadcast other media, such as images, videos, and maps.

User interface 26 may also be configured to receive user-defined settings. For example, user interface 26 may be configured to receive occupant profiles including, for example, an age, a gender, a driving license status, an advanced driver assistance systems (ADAS) license status, an individual driving habit, a frequent destination, a store reward program membership, favorite food, and etc. In some embodiments, user interface 26 may include a touch-sensitive surface configured to receive biometric data (e.g., detect a fingerprint of an occupant). The touch-sensitive surface may be configured to detect the ridges and furrows of a fingerprint based on a change in capacitance and generate a signal based on the detected fingerprint, which may be processed by an onboard computer described below with reference to FIG. 4. The onboard computer may be configured to compare the signal with stored data to determine whether the fingerprint matches recognized occupants. The onboard computer may also be able to connect to the Internet, obtain data from the Internet, and compare the signal with obtained data to identify the occupants. User interface 26 may be configured to include biometric data into a signal, such that the onboard computer may be configured to identify the person generating an input. User interface 26 may also compare a received voice input with stored voices to identify the person generating the input. Furthermore, user interface 26 may be configured to store data history accessed by the identified person.

In some embodiments, sensor 36 may include one or sensors, such as a camera, a microphone sound detection sensor, an infrared sensor, a weight sensor, a radar, an ultrasonic, a LIDAR sensor, or a wireless sensor. Sensor 36 may be configured to generate a signal to be processed to detect and/or recognize occupants of vehicle 10. In one example, sensor 36 may obtain identifications from occupants' cell phones. In another example, a camera 36 may be positioned on the back of a headrest 34 of a front seat 30 to capture images of an occupant in a back seat 32. In some embodiments, visually captured videos or images of the interior of vehicle 10 by camera 36 may be used in conjunction with an image recognition software, such that the software may distinguish a person from inanimate objects, and may recognize the person based on physical appearances or traits. The image recognition software may include a facial recognition software configured to match a captured occupant with stored profiles to identify the occupant. In some embodiments, more than one sensor may be used in conjunction to detect and/or recognize the occupant(s). For example, sensor 36 may include a camera and a microphone, and captured images and voices may both work as filters to identify the occupant(s) based on the stored profiles.

In some embodiments, sensor 36 may include one or more electrophysiological sensors for encephalography-based autonomous driving. For example, a fixed sensor 36 may detect electrical activities of brains of the occupant(s) and convert the electrical activities to signals, such that the onboard computer can control the vehicle based on the signals. Sensor 36 may also be detachable and head-mountable, and may detect the electrical activities when worn by the occupant(s).

Vehicle 10 may be in communication with a plurality of mobile communication devices 80, 82. Mobile communication devices 80, 82 may include a number of different structures. For example, mobile communication devices 80, 82 may include a smart phone, a tablet, a personal computer, a wearable device, such as a smart watch or Google Glass™, and/or complimentary components. Mobile communication devices 80, 82 may be configured to connect to a network, such as a nationwide cellular network, a local wireless network (e.g., Bluetooth™ or WiFi), and/or a wired network. Mobile communication devices 80, 82 may also be configured to access apps and websites of third parties, such as iTunes™, Pandora™, Google™, Facebook™, and Yelp™.

In some embodiments, mobile communication devices 80, 82 may be carried by or associated with one or more occupants in vehicle 10. For example, vehicle 10 may be configured to determine the presence of specific people based on a digital signature or other identification information from mobile communication devices 80, 82. For instance, an onboard computer may be configured to relate the digital signature to stored profile data including the person's name and the person's relationship with vehicle 10. The digital signature of mobile communication devices 80, 82 may include a determinative emitted radio frequency (RF) or a global positioning system (GPS) tag. Mobile communication devices 80, 82 may be configured to automatically connect to or be detected by vehicle 10 through local network 70, e.g., Bluetooth™ or WiFi, when positioned within a proximity (e.g., within vehicle 10).

FIG. 4 is a block diagram illustrating an air control system 11, consistent with exemplary embodiments of the present disclosure. System 11 may include a number of components, some of which may be optional. As illustrated in FIG. 4, system 11 may include vehicle 10, as well as other external devices connected to vehicle 10 through network 70. The external devices may include mobile communication devices 80, 82, and third party device 90. Vehicle 10 may include a specialized onboard computer 100, a controller 120, an actuator system 130, an indicator system 140, a sensor 36, a user interface 26, and a detector and GPS unit 24. Onboard computer 100, actuator system 130, and indicator system 140 may all connect to controller 120. Sensor 36, user interface 26, and detector and GPS unit 24 may all connect to onboard computer 100. Onboard computer 100 may comprise, among other things, an I/O interface 102, a processing unit 104, a storage unit 106, a memory module 108. The above units of system 11 may be configured to transfer data and send or receive instructions between or among each other. Storage unit 106 and memory module 108 may be non-transitory and computer-readable and store instructions that, when executed by processing unit 104, cause system 11 or vehicle 10 to perform the methods described in this disclosure. Onboard computer 100 may be specialized to perform the methods and steps described below.

I/O interface 102 may also be configured for two-way communication between onboard computer 100 and various components of system 11, such as user interface 26, detector and GPS 24, sensor 36, and the external devices. I/O interface 102 may send and receive operating signals to and from mobile communication devices 80, 82 and third party devices 90. I/O interface 102 may send and receive the data between each of the devices via communication cables, wireless networks, or other communication mediums. For example, mobile communication devices 80, 82 and third party devices 90 may be configured to send and receive signals to I/O interface 102 via a network 70. Network 70 may be any type of wired or wireless network that may facilitate transmitting and receiving data. For example, network 70 may be a nationwide cellular network, a local wireless network (e.g., Bluetooth™ or WiFi), and/or a wired network.

Third party devices 90 may include smart phones, personal computers, laptops, pads, servers, and/or processors of third parties that provide access to contents and/or data (e.g., maps, traffic, store locations, weather, instruction, command, user input). Third party devices 90 may be accessible to the users through mobile communication devices 80, 82 or directly accessible by onboard computer 100, via I/O interface 102, according to respective authorizations of the user. For example, users may allow onboard computer 100 to receive third party contents by configuring settings of accounts with third party devices 90 or settings of mobile communication devices 80, 82.

In some embodiments, sensor 36, user interface 26, mobile communication devices 80, 82, and/or third party device 90 may be configured to receive the user input described above. Sensor 36, user interface 26, mobile communication devices 80, 82, and/or third party device 90 may also be configured to receive an air setting and/or an air control device setting. The air setting may comprise at least one of a temperature setting, a wind speed setting, a humidity setting, a vapor setting, or a scent setting. The air control device setting may comprise at least one of an air outlet direction setting of the air control device or a position setting of the air control device.

Processing unit 104 may be configured to receive signals (e.g., the seat status, the seat direction, the user input, the air setting, and/or the air control device setting described above) and process the signals to determine a plurality of conditions of the operation of vehicle 10, for example, operations of sensor 36 and operations of indicator system 140 through controller 120. Processing unit 104 may also be configured to generate and transmit command signals, via I/O interface 102, in order to actuate the devices in communication.

In some embodiments, processing unit 104 may be configured to determine the presence of people within an area, such as occupants of vehicle 10. Processing unit 104 may be configured to determine the identity of the occupants through a variety of mechanisms. For example, processing unit 104 may be configured to determine the presence of specific people based on a digital signature from mobile communication devices 80, 82. For instance, processing unit 104 may be configured to relate the digital signature to stored data including the person's name and the person's relationship with vehicle 10. The digital signature of communication device 80 may include a determinative emitted radio frequency (RF), GPS, Bluetooth™, or WiFi unique identifier. Processing unit 104 may also be configured to determine the presence of people within vehicle 10 by GPS tracking software of mobile communication devices 80, 82. In some embodiments, vehicle 10 may be configured to detect mobile communication devices 80, 82 when mobile communication devices 80, 82 connect to local network 70 (e.g., Bluetooth™ or WiFi).

In some embodiments, processing unit 104 may also be configured to recognize occupants of vehicle 10 by receiving inputs with user interface 26. For example, user interface 26 may be configured to receive direct inputs of the identities of the occupants. User interface 26 may also be configured to receive biometric data (e.g., fingerprints) from occupants when manipulating user interface 26. Processing unit 104 may be further configured to recognize occupants by facial recognition software used in conjunction with sensor 36.

In some embodiments, processing unit 104 may be configured to access and collect sets of data related to the people within the area in a number of different manners. Processing unit 104 may be configured to store the sets of data in a database. In some embodiments, processing unit 104 may be configured to access sets of data stored on mobile communication devices 80, 82, such as apps, audio files, text messages, notes, messages, photos, and videos. Processing unit 104 may also be configured to access accounts associated with third party devices 90, by either accessing the data through mobile communication devices 80, 82 or directly accessing the data from third party devices 90. Processing unit 104 may be configured to receive data directly from occupants, for example, through access of user interface 26. For example, occupants may be able to directly input vehicle settings, such as a desired temperature. Processing unit 104 may also be configured to receive data from history of previous inputs of the occupant into user interface 26.

In some embodiments, processing unit 104 may be configured to extract data from the collected sets of data to determine the occupant's interests and store the extracted data in a database. For example, processing unit 104 may be configured to determine favorite temperature ranges of a particular occupant. Processing unit 104 may be configured to store data related to an occupant's previous destinations and purchase histories using vehicle 10. Processing unit 104 may further be configured to execute character recognition software to determine the contents of messages or posts of occupants on social media to recognize keywords related to interests. For another example, processing unit 104 determine that a person likes a dry and cool environment according to that person's social media posts. Processing unit 104 can extract and store such information in association with individual profiles.

Storage unit 106 and/or memory module 108 may be configured to store one or more computer programs that may be executed by onboard computer 100 to perform functions of system 11. For example, storage unit 106 and/or memory module 108 may be configured to store biometric data detection and processing software configured to determine the identity of people based on fingerprint(s), and store image recognition software configured to relate images to identities of people. Storage unit 106 and/or memory module 108 may be further configured to store data and/or look-up tables used by processing unit 104. For example, storage unit 106 and/or memory module 108 may be configured to include data related to individualized profiles of people related to vehicle 10. In some embodiments, storage unit 106 and/or memory module 108 may store the stored data and/or the database described in this disclosure.

Vehicle 10 can also include a controller 120 connected to the onboard computer 100 and capable of controlling one or more aspects of vehicle operation, such as performing autonomous parking or driving operations using instructions from the on-board computer 100.

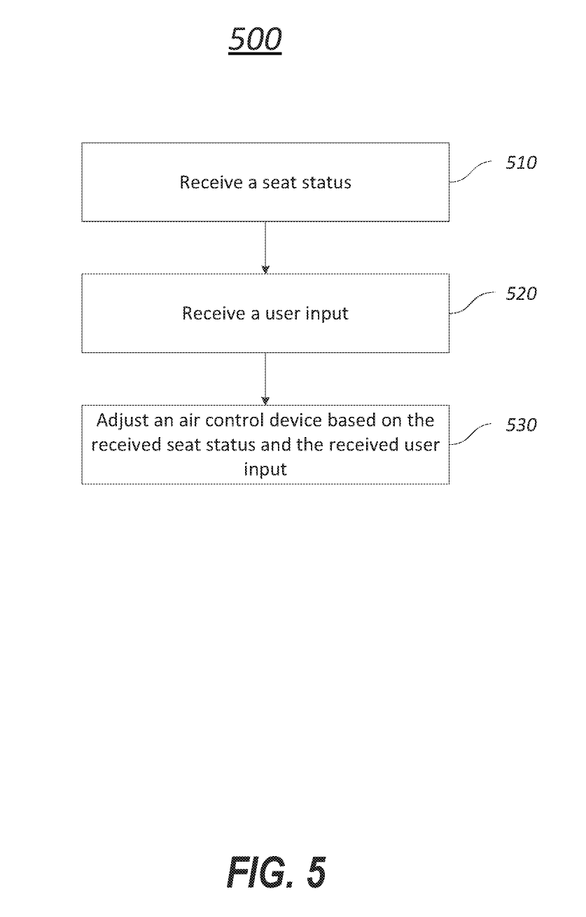

In some examples, the controller 120 is connected to one or more actuator systems 130 in the vehicle and one or more indicator systems 140 in the vehicle. The one or more actuator systems 130 can include, but are not limited to, a motor 131 or engine 132, battery system 133, transmission gearing 134, suspension setup 135, brakes 136, steering system 137, door system 138, air control apparatus 139, and one or more seats 1310. Steering system 137 may include steering wheel 22 described above with reference to FIG. 1. The onboard computer 100 can control, via controller 120, one or more of these actuator systems 130 during vehicle operation; for example, to open or close one or more of the doors of the vehicle using the door actuator system 138, to control the vehicle during autonomous driving or parking operations, using the motor 131 or engine 132, battery system 133, transmission gearing 134, suspension setup 135, brakes 136 and/or steering system 137, etc. Air control apparatus 139 may comprise the one or more air control devices 50, one or more ducts 51, compressor 54, condenser 53, and evaporator 52 described above. As described above, air control devices 50 may be configured to facilitate flowing of the controlled air in a configurable direction and/or position. The air control and the direction or position configuration may be performed by processing unit 104 via sensor 36, user interface 26, mobile communication devices 80, 82, and/or third party device 90. More details are described below with reference to FIG. 5. Seats 1310 may comprise front seats 30, back seats 32, and one or more seat sensors 1311 described above. Seat sensors 1311 may transmit sensor signals to processing unit 104. The one or more indicator systems 140 can include, but are not limited to, one or more speakers 141 in the vehicle (e.g., as part of an entertainment system in the vehicle or part of user interface 26), one or more lights 142 in the vehicle, one or more displays 143 in the vehicle (e.g., as part of a control or entertainment system in the vehicle) and one or more tactile actuators 144 in the vehicle (e.g., as part of a steering wheel or seat in the vehicle). Onboard computer 100 can control, via controller 120, one or more of these indicator systems 140 to provide indications to a driver of the vehicle of one or more characteristics of the vehicle's surroundings. The characteristics may be determined by sensor 36.

FIG. 5 is a flowchart illustrating an air control method 500, consistent with exemplary embodiments of the present disclosure. Method 500 may include a number of steps and sub-steps, some of which may be optional, e.g., step 520. The steps or sub-steps may also be rearranged in another order.

In Step 510, one or more components of system 11, e.g., processing unit 104, may receive a seat status. In some embodiments, the seat status may include a seat direction, e.g., facing front, side, or back of the vehicle, the direction that the seat faces with respect to the vertical direction, and/or the seat's yaw, pitch, or roll angle in the 3D space. The seat direction may be monitored by the seat sensors 1311 described above, which transmit corresponding signals to processing unit 104. The seat directions may also be monitored by sensor 36, mobile communication devices 80, 82, and/or user interface 26 described above, which may transmit corresponding signals to processing unit 104. For example, sensor 36 may include a camera configured to recognize the seat direction based on an image recognition software. For another example, mobile communication device 80 may capture an image of a seat to determine the seat direction by image recognition, or be attached to a seat to determine the seat direction by a gimbal sensor inside the mobile communication device.

In some embodiments, the seat status may also include whether the seat is occupied (e.g., by a person, a pet, or an item), and/or identities of the person, pet, or item, both of which may be monitored by seat sensors 1311, sensor 36, mobile communication devices 80, 82, and/or user interface 26. That is, vehicle 10 may detect a number of occupants in vehicle 10 and their identities. For example, sensor 36 may include a cellphone detection sensor that detect the occupants according to mobile communication devices 80, 82 connected to a local wireless network (e.g., Bluetooth™) of vehicle 10, and transmit the detected number to processing unit 104. For another example, user interface 26 may detect the occupants according to manual entry of data into vehicle 10, e.g., occupants selecting individual names through user interface 26, and transmit the detected number to processing unit 104. Processing unit 104 may also collect biometric data (e.g., fingerprint data) from the occupants through user interface 26. For another example, sensor 36 may include cameras that capture images of occupants, microphones that capture voices of occupants, and/or weight sensors that capture weights of objects on the vehicle seats. Based on the received data from these sensors, processing unit 104 may determine associated profiles of the occupants in vehicle 10.

In some embodiments, one or components of system 11 may determine each occupant's identity, by executing a software such as an image recognition software, a voice recognition software, or a weight recognition software, based on the received data from sensor 36 and/or user interface 26. For example, sensor 36 may detect a digital signature or other identification information from mobile communication devices that occupants carry, and processing unit 104 may determine the occupants' identifies based on the digital signatures. Processing unit 104 may access, collect, and update sets of data related to each occupant in vehicle 10. Processing unit 104 may determine whether the determined occupants have stored profiles. Processing unit 104 may also access sets of data stored on mobile communication device 80, 82 and third party devices 90 to update the stored profile(s). If an occupant does not have a stored profile, processing unit 104 may generate a profile based on the accessed data. Each profile may include information such as age, gender, driving license status, driving habit, frequent destination, favorite food, shopping habit, and enrolled store reward program. For example, processing unit 104 may determine the interests of one or more (e.g., each) of the occupants of vehicle 10 according to their enrolled store reward programs. Processing unit 104 may determine each of the occupant's preferences, for example, in temperature setting and humidity setting.

In Step 520, one or more components of system 11 may receive a user input. The user input may comprise an air setting and/or an air control device setting. The air setting may comprise a temperature setting, a wind speed setting, a humidity setting, a vapor setting, and/or a scent setting. The air control device setting may comprise an outlet direction setting and a position setting of air control devices 50. In some embodiments, processing unit 104 may receive the user input from someone operating mobile communication device 80, 82, or third party device 90. For example, a person may use first mobile communication device 80 to input an A/C setting.

In some embodiments, processing unit 104 may receive the user input from a current occupant of vehicle 10 via sensor 36 and/or user interface 25. An occupant of vehicle 10 may input an air device control setting through user interface 26, such as directly entering a setting. An occupant of vehicle 10 may also enter the user input through sensor 36, such as sending instructions through the electrophysiological sensors. Also, sensor 36 may detect a special gesture of an occupant, the gesture associated with a user input. In some embodiments, vehicle 10 may determine the air setting and/or the air control device setting. For example, processing unit 104 may store data such as personal air settings at storage unit 106 and/or memory module 108. After determining an occupant's identity, processing unit 104 may recommend the occupant's personal air setting as the user input.

In some embodiments, an occupant's settings may be stored by the onboard computer 100, and the onboard computer 100 recognize the occupant on the vehicle, the onboard computer 100 may automatically apply the occupant's saved settings by retrieving such information from the corresponding profile. The saved settings may direct to a temperature, a humidity, a wind speed, a vapor, and/or a scent. In these embodiments, the step of receiving a user's input may be omitted. More details of applying such settings are described below with reference to Step 530.

In Step 530, one or more components of system 11, e.g., processing unit 104, may adjust an air control device based on the received seat status and the received user input. As described above with reference to FIG. 1, air control devices 50 may be each associated with a seat and/or a status of the seat. Thus, processing unit 104 may adjust air control devices 50 based on the received seat status and user input. For example, if processing unit 104 receives a status of seat A being facing backwards and receives an user input to auto-adjust the air control devices, processing unit 104 may turn off air control devices associated with seat A facing forward (e.g., air control device 50f described above) and turn on air control devices associated with seat A facing backward (e.g., air control devices 50a and 50b described above).

In some embodiments, vehicle 10 may be driverless and can perform the methods and steps disclosed herein without a driver. The driver seat may also be rotatable and can be adjusted by the disclosed methods and devices.

In some embodiments, processing unit 104 can adjust the air control devices according to the profile. For example, a user may prefer turning on a selected number of air control devices and setting to a low humidity when sitting on a reversed seat. Processing unit 104 may turn on such personal settings if identifying that user on a reversed seat. Processing unit 104 may also configure air control devices to achieve that personal setting only for that user's seating area/zone.

In some embodiments, processing unit 104 may adjust the air control devices according to a weather condition. Detector and GPS unit 24 may monitor a weather condition including, for example, weather, temperature, wind speed, humidity, and sun position. For example, if the weather is sunny at 90 degrees outside, processing unit 104 may turn down temperature setting and turn up the wind speed of the controlled air. Also, if sensor 36 detects that the sun is shining on a reversed seat, processing unit 104 may adjust the air control devices to lower temperature of controlled air directed towards the reversed seat. Alternatively, processing unit 104 may control mechanics to pull down window curtains or shades to block sun light towards the reversed seat. Alternatively, processing unit 104 may auto-taint windows by switching on electrochromatic window films in the path from the sun to the reversed seat.

In some embodiments, processing unit 104 may determine an air control for a particular section of the vehicle. For example, if passengers on a third row of the vehicle are watching a movie, processing unit 104 may only adjust air control devices associated with the third row to keep them alert by, for example, lowering the air temperature.

In some embodiments, processing unit 104 may control the humidifier, vaporizer or air diffuser of the air control device, according to sensor signals, user settings, and/or user profiles. For example, sensor 36 may include a humidity sensor configured to monitor an interior humidity of the vehicle, and processing unit 104 may turn on the humidifier when the humidity is below a threshold. For another example, processing unit 104 may turn on a vaporizer according to a user profile to scent the controlled air at a predetermined time or time period (e.g., 5 minutes before the user enters the vehicle). If the processing unit 104 determines that the user has left the vehicle, it may stop scenting the controlled air.

In some embodiments, the user input may include identities of one or more users and/or a time for them entering the vehicle. Processing unit 104 may determine the occupants profiles and preferences of the air setting and the air control device setting. Processing unit 104 may adjust the air control devices, such that when they enter the vehicle the air condition matches with their preferences. For example, processing unit 104 may adjust the air control devices before they enter the vehicle according to their air control references associated with their profiles. For another example, processing unit 104 may communicate with a household thermostat to receive a current temperature and humidity of the house where the users are resting before entering the vehicle, and adjust the air control devices to achieve the same temperature and humidity level just before they enter the vehicle. Such setting can also be dynamically adjusted after the trip starts.

In some embodiments, the above-described systems and methods can be applied to competition vehicles, such as race cars and motorcycles. The systems and methods can be implemented to assist with racing by providing better air control for vehicle occupants. Output generated by systems can be transmitted to third party device 90, e.g., a computer, for further analysis by a race crew.

In some embodiments, the above-described systems and methods can be applied to vehicles in a platoon. Vehicles traveling in a platoon may travel in a formation with small separations, and accelerate and brake together. Autonomous vehicles may join or leave the platoon formation automatically. Vehicle 10 may consider the presence of a platoon in executing the disclosed method, since moving in a platoon may conserve vehicle power and provide a more effective air control.

Another aspect of the disclosure is directed to a non-transitory computer-readable medium storing instructions which, when executed, cause one or more processors to perform the method, as discussed above. The computer-readable medium may include volatile or non-volatile, magnetic, semiconductor, tape, optical, removable, non-removable, or other types of computer-readable storage medium or computer-readable storage devices. For example, the computer-readable medium may be the storage unit or the memory module having the computer instructions stored thereon, as disclosed. In some embodiments, the computer-readable medium may be a disc or a flash drive having the computer instructions stored thereon.

A person skilled in the art can further understand that, various exemplary logic blocks, modules, circuits, and algorithm steps described with reference to the disclosure herein may be implemented as specialized electronic hardware, computer software, or a combination of electronic hardware and computer software. For examples, the modules/units may be implemented by one or more processors to cause the one or more processors to become one or more special purpose processors to executing software instructions stored in the computer-readable storage medium to perform the specialized functions of the modules/units.

The flowcharts and block diagrams in the accompanying drawings show system architectures, functions, and operations of possible implementations of the system and method according to multiple embodiments of the present invention. In this regard, each block in the flowchart or block diagram may represent one module, one program segment, or a part of code, where the module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on the functions involved. Each block in the block diagram and/or flowchart, and a combination of blocks in the block diagram and/or flowchart, may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware for allowing specialized components to perform the functions described above. Furthermore, embodiments of the present disclosure may take the form of a computer program product embodied in one or more tangible and/or non-transitory computer-readable storage media containing computer-readable program codes. Common forms of non-transitory computer readable storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Embodiments of the present disclosure are described with reference to flow diagrams and/or block diagrams of methods, devices (systems), and computer program products according to embodiments of the present disclosure. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a computer, an embedded processor, or other programmable data processing devices to produce a special purpose machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer-readable memory that can direct a computer or other programmable data processing devices to function in a particular manner, such that the instructions stored in the computer-readable memory produce a manufactured product including an instruction means that implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions (which are executed on the computer or other programmable devices) provide steps for implementing the functions specified in one or more flows in the flow diagrams and/or one or more blocks in the block diagrams. In a typical configuration, a computer device includes one or more Central Processing Units (CPUs), an input/output interface, a network interface, and a memory. The memory may include forms of a volatile memory, a random access memory (RAM), and/or non-volatile memory and the like, such as a read-only memory (ROM) or a flash RAM in a computer-readable storage medium. The memory is an example of the computer-readable storage medium.

The computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The computer-readable medium includes non-volatile and volatile media, and removable and non-removable media, wherein information storage can be implemented with any method or technology. Information may be modules of computer-readable instructions, data structures and programs, or other data. Examples of a non-transitory computer-readable medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, a cache, a register, or any other non-transmission media that may be used to store information capable of being accessed by a computer device. The computer-readable storage medium is non-transitory, and does not include transitory media, such as modulated data signals and carrier waves.

The specification has described air control methods, apparatus, and systems. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with the disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. An air control system, comprising a processing unit configured to:
receive a seat status; and
adjust an air control device based on the received seat status.

2. The system of claim 1, wherein the seat status comprises a direction the seat is facing.

3. The system of claim 2, wherein the seat status further comprises whether the seat is occupied.

4. The system of claim 1, wherein the processing unit is further configured to:
receive a user input comprising at least one of an air setting or an air control device setting; and
adjust the one or more air control devices based on the received seat status and the received user input.

5. The system of claim 4, wherein:
the air setting comprises at least one of a temperature setting, a wind speed setting, a humidity setting, a vapor setting, or a scent setting; and
the air control device setting comprises at least one of an air outlet direction setting of the air control device or a position setting of the air control device.

6. The system of claim 1, wherein the seat has one or more seat statuses each associated with one or more of the air control devices.

7. The system of claim 1, wherein the processing unit is further configured to:
determine a profile of a seat occupant, the profile associated with one or more of the air control devices; and
adjust the one or more air control devices based on the received seat status and the determined profile.

8. The system of claim 1, wherein:
the air control device comprises an air outlet configured to deliver a controlled air to a configurable position in a configurable direction; and
the air control device is configured to control at least one of a temperature, a wind speed, a humidity, a vapor content, or a diffusion content of the controlled air.

9. The system of claim 1, wherein the processing unit is further configured to determine a direction of the sun and adjust the air control device based on the determined direction of the sun.

10. A vehicle comprising an air control system, the system comprising a processing unit configured to:
receive a seat status; and
adjust an air control device based on the received seat status.

11. The vehicle of claim 10, wherein the seat status comprises a direction the seat is facing.

12. The vehicle of claim 11, wherein the seat status further comprises whether the seat is occupied.

13. The vehicle of claim 10, wherein the processing unit is further configured to:
receive a user input comprising at least one of an air setting or an air control device setting; and
adjust the one or more air control devices based on the received seat status and the received user input.

14. The vehicle of claim 13, wherein:
the air setting comprises at least one of a temperature setting, a wind speed setting, a humidity setting, a vapor setting, or a scent setting; and
the air control device setting comprises at least one of an air outlet direction setting of the air control device or a position setting of the air control device.

15. The vehicle of claim 10, wherein the seat has one or more seat statuses each associated with one or more of the air control devices.

16. The vehicle of claim 10, wherein the processing unit is further configured to:
determine a profile of a seat occupant, the profile associated with one or more of the air control devices; and
adjust the one or more air control devices based on the received seat status and the determined profile.

17. The vehicle of claim 10, wherein:
the air control device comprises an air outlet configured to deliver a controlled air to a configurable position in a configurable direction; and
the air control device is configured to control at least one of a temperature, a wind speed, a humidity, a vapor content, or a diffusion content of the controlled air.

18. The vehicle of claim 10, wherein the processing unit is further configured to determine a direction of the sun and adjust the air control device based on the determined direction of the sun.

19. A method for air control, comprising:
receiving a seat status; and
adjusting an air control device based on the received seat status.

20. The method of claim 19, wherein:
the seat status comprises a direction the seat is facing; and
adjusting the air control device based on the received seat status comprises at least one of:
turning on or off the air control device;
adjusting a position of the air control device; or
adjusting a direction of an air outlet of the air control device.
